(19) United States
(12) Patent Application Publication
(10) Pub. No.: US 2016/0253684 A1
(43) Pub. Date: Sep. 1, 2016

(54) SYSTEMS AND METHODS OF STRUCTURING REVIEWS WITH AUTO-GENERATED TAGS

(71) Applicant: Google Inc., Mountain View, CA (US)

(72) Inventors: Huazhong Ning, San Jose, CA (US); Cheng Sheng, Fremont, CA (US); Wei Chai, Cupertino, CA (US); Hrishikesh Balkrishna Aradhye, Santa Clara, CA (US)

(21) Appl. No.: 14/633,227

(22) Filed: Feb. 27, 2015

(51) Int. Cl. G06Q 30/02

(52) U.S. Cl. CPC G06Q 30/0201

(57) ABSTRACT

Systems and methods of structures reviews through auto-generated tags are provided that include providing, with a computing device having an input device and a display device, a user interface to receive a review for an object from a reviewer, selecting a set of tags from an object tag collection stored in a database communicatively coupled to the computing device according to the object and the reviewer, displaying, by the display device of the computing device, the selected set of tags on a display, receiving an input, by the input device, to remove one or more of the displayed tags, and storing, by a storage device, the remaining tags of the set of tags that are submitted according to the received input for the object.

### BACKGROUND

Currently, many online sites allow users to write reviews for objects available on or referred to by the site, such as applications (i.e., an “app”), movies, books, hotels, restaurants, or the like. The reviews can be associated with the object and can be relied upon by other users in making viewing or purchasing decisions. A user interface (“UI”) for providing a review often includes a text box for the user to enter the review. There can also be a place for the user to enter an overall score for the reviewed object.

It can be difficult for a user to write a review on a smartphone or other mobile device because such devices often have smaller screen sizes and lack full-sized keyboards. As a result, users are often reluctant to provide reviews, or else provide abbreviated text that may be less useful to others. Another problem relates to the large number of reviews that may be posted for an object. For example, a popular movie may have hundreds of screen pages of reviews submitted by users. Since few users have the time to read all or even most reviews for some objects, it can be difficult for the user to gain an accurate sense of other users' experiences of the object.

### BRIEF SUMMARY

Embodiments of the disclosed subject matter provide systems and methods to allow users to efficiently provide high-quality and structured reviews with minimal input to a user interface. The quality of reviews and the reduced input required to enter review may attract more users to provide reviews and/or read reviews.

According to an embodiment of the disclosed subject matter, a method includes providing, with a computing device having an input device and a display device, a user interface to receive a review for an object from a reviewer, selecting a set of tags from an object tag collection stored in a database communicatively coupled to the computing device according to the object and the reviewer, displaying, by the display device of the computing device, the selected set of tags on a display, receiving an input, by the input device, to remove one or more of the displayed tags, and storing, by a storage device, the remaining tags of the set of tags that are submitted according to the received input for the object.

According to an embodiment of the disclosed subject matter, a system is provided that includes a computing device to provide a user interface to receive a review for an object from a reviewer, a database communicatively coupled to the computing device to store an object tag collection, a display device, coupled to the computing device, to display a set of tags selected by the computing device from the database, an input device, coupled to the computing device, to receive an input to remove one or more of the displayed tags on the display device, and a storage device, coupled to the computing device, to store the remaining tags of the set of tags that are submitted according to the received input for the object.

An embodiment of the disclosed subject matter may provide a non-transitory computer readable medium including instructions, that when executed by a computer, perform a method including selecting, with a server, a set of tags from an object tag collection stored in a database communicatively coupled to the server according to an object to be reviewed and a reviewer, providing the selected set of tags from the server to a computing device of the reviewer, receiving, with the server, input data from the computing device to remove one or more of the tags from the selected set of tags, and storing, by a storage device, the remaining tags of the set of tags so as to be associated with the reviewer and the object.

According to an embodiment of the disclosed subject matter, means for structured reviews through auto-generated tags are provided so as to include providing, with a computing device having an input device and a display device, a user interface to receive a review for a object from a reviewer, selecting a set of tags from an object tag collection stored in a database communicatively coupled to the computing device according to the object and the reviewer, displaying, by the display device of the computing device, the selected set of tags on a display, receiving an input, by the input device, to remove one or more of the displayed tags, and storing, by a storage device, the remaining tags of the set of tags that are submitted according to the received input for the object.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example method according to an embodiment of the disclosed subject matter.

FIG. 2 shows a hierarchical diagram of a structured review system according to an embodiment of the disclosed subject matter.

FIG. 3 shows an example display according to an embodiment of the disclosed subject matter.

FIG. 4 shows a computing device according to an embodiment of the disclosed subject matter.

FIG. 5 shows a network configuration according to an embodiment of the disclosed subject matter.

FIG. 6 shows an example network and system configuration according to an embodiment of the disclosed subject matter

### DETAILED DESCRIPTION

Embodiments of the disclosed subject matter can efficiently collect high-quality user reviews of objects while requiring less textual input from the reviewers. This can make it easier for users to submit more accurate reviews. Further, the submitted reviews may be more accurately summarized. Even a large number of reviews can thus be made more useful to other users.

In embodiments of the disclosed subject matter, structured reviews can be read by computers and/or machines so that useful information may be mined and/or extracted from the reviews. For each object (e.g., an app, a movie, a book, a hotel, a restaurant, a product, or the like), a collection of machine-readable tags can be generated that may be related to the object. For each reviewer, a set of tags from the collection can be selected based on their possible relevance to the object and presented to the reviewer. The reviewer may remove the tags that are not related to the object and/or are inconsistent with the reviewer's opinion about the object. The tags left by the reviewer may be stored by the system in connection with the object as a structured review.

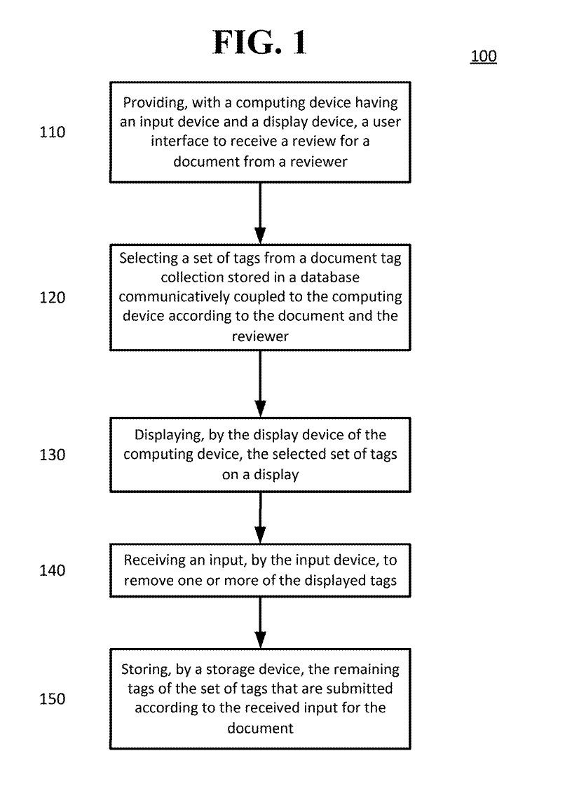

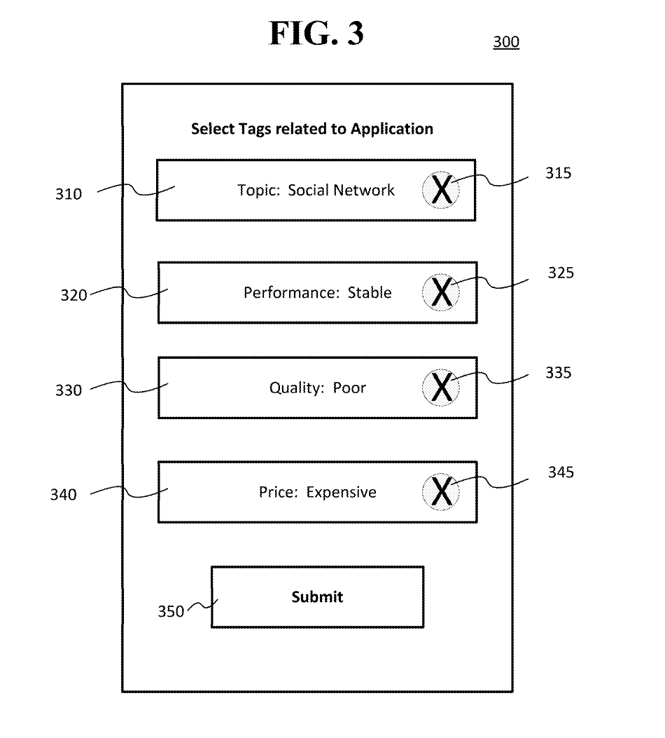

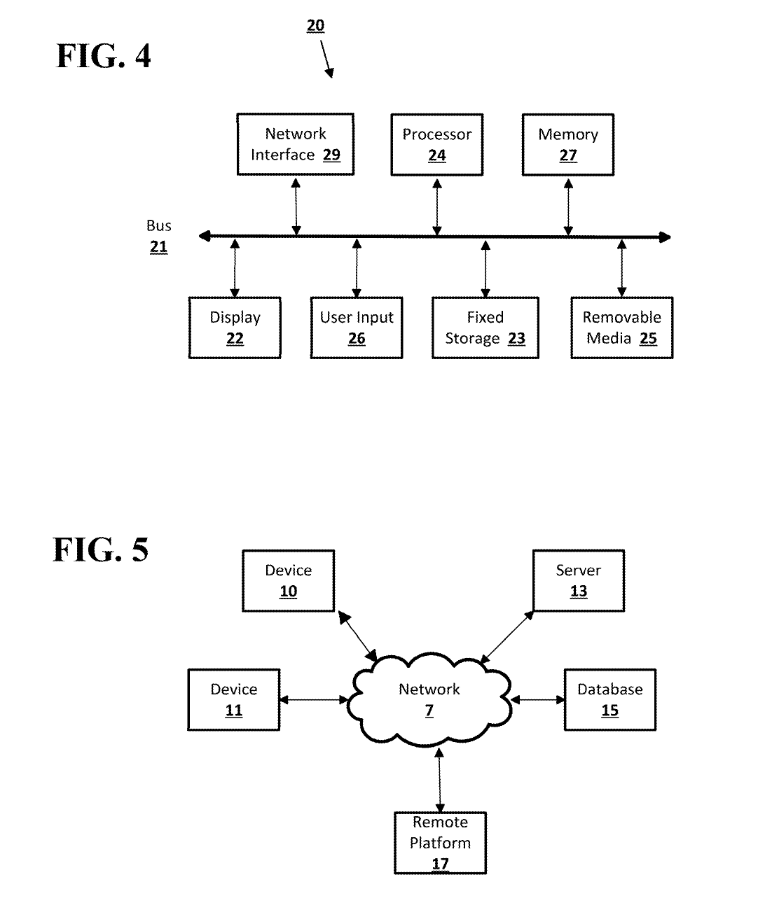

In an embodiment of the disclosed subject matter, a method 100 shown in FIG. 1 provides such structured reviews through auto-generated tags. With a computing device (e.g., device 20 shown in FIG. 4 and/or device 10, 11 shown in FIG. 5) having an input device (e.g., user input 26 shown in FIG. 4) and a display device (e.g., display 22 shown in FIG. 4), a user interface (e.g., user interface 300 shown in FIG. 3) may be provided to receive a review for an object from a reviewer in operation 110. The object may be an application (i.e., “app”), a movie, a restaurant, a hotel, a tourist attraction, a product, or the like.

A set of tags can be selected from an object tag collection stored in a database communicatively coupled to the computing device according to the object and the reviewer at operation 120. In some embodiments, as shown in FIG. 5 and discussed below, a database 15 and/or server 13 may include the object tag collection, and may select a set of tags to be presented by device 10, 11 communicatively coupled to the database 15 and/or server 13 via the network 7. The set of tags that may be select may include, for example, topic tags, quality tags, price tags, and definable tags. The tags may differ in meaning, depending upon the object to be reviewed.

Topic tags may describe the topics and/or genres about the objects. For example, a social networking application to be reviewed (i.e., an object to be reviewed) can be tagged with “Topic: Social Network”, “Topic: Instant Messaging”, or the like. Quality tags may describe the quality of the objects. For example, when the object to be reviewed is an application, the quality tags may be “Quality: Slow”, “Quality: Fast”, “Quality: Stable”, “Quality: Poor”, or the like. That is, the quality tags may relate to the speed, stability, and/or overall usefulness of the application. In another example, where the object to be reviewed is a hotel, the quality tags may include “Quality: Clean”, “Quality: Dirty”, “Quality: Friendly”, “Quality: Quiet”, or the like. That is, the quality tags may relate to the cleanliness, the demeanor of the staff, the ambiance of the hotel, or the like. Price tags may describe the price of the object with respect to value. For example, the price tags may include “Price: Expensive”, “Price: Free”, “Price: $50-$100” or the like. In some embodiments, types of tags may be defined depending on the characteristics of the object or objects to which they pertain. Such tags may be referred to as definable tags.

The display device (e.g., display 22 shown in FIG. 4) of the computing device (e.g., device 20 shown in FIG. 4) can display the selected set of tags on a display at operation 130. For example, User Interface (“UI”) 300 shown in FIG. 3 is an example of a set of displayed tags related to an application to be reviewed. At operation 140 shown in FIG. 1, the input device (e.g., user input 26 shown in FIG. 4) may receive an input to remove one or more of the displayed tags. As shown in FIG. 3, one or more of inputs 315, 325, 335, and 345 may be selected to remove respective tags 310, 320, 330, and 340. The reviewer may remove the tags, as the tags may not be related to the object. A storage device (e.g., fixed storage 23 and/or removable media 25 shown in FIG. 4, and/or a server 13 and/or database 15 shown in FIG. 5) may store the remaining tags (i.e., the non-removed tags of the set of tags) that are submitted according to the received input for the object at operation 150. For example, as shown in FIG. 3, the submit button 350 may be selected by a user to store the remaining tags.

Embodiments of the disclosed subject matter may include storing, by the database, a date and time of a review activity by the reviewer. That is, a date and time of any user selections, for example, in UI 300 shown in FIG. 3 may be stored in the database (e.g., where the selections include which object to review, which tags to select for removal, which tags to store with a reviewed application, and the like). The method may include storing, by the database, the set of tags selected and displayed by the computing device for the reviewer. The database may store the one or more tags removed by the reviewer. That is, the system may store which tags were selected to be displayed to the user in connection with an object such as a document to be reviewed, as well as the tags that are removed by the user and those tags that remain (e.g., the tags that are elected to be stored after the removal of tags). The database may store the amount of time spent by the user for a review activity. That is, the system disclosed herein may monitor the amount of time a reviewer spends in a review activity, and, for example, adjust the selection of tags so as to reduce the amount of time for the review activity. Alternatively, the system may adjust the user interface and/or presentation of the object and/or tags to be reviewed so as to reduce the review activity time.

The method of the disclosed subject matter may include predicting, with the computing device (e.g., device 20 shown in FIG. 4, or a server 13 shown in FIG. 5), a probability that the reviewer would submit a tag from the set of tags, according to a stored history of the reviewer and the object. The stored history of the reviewer may include, for example, demographics, languages, interests, or the like. The probability that the reviewer submits a tag from the set of tags can be according to an object feature such as a topic, number of likes, number of dislikes, quality, or the like.

In embodiments of the disclosed subject matter, the set of objects reviewed and the review tags associated with each object submitted according to the received user input from the reviewer may be stored in the database (e.g., database 15 shown in FIG. 5).

The selecting the set of tags from an object tag collection in the method 100 described above may include, for example, selecting the set of tags so as to minimize the reviewer inputs for each review and maximize information obtained from the review. That is, the system may use the data stored in the database (e.g., amount of review time or the like) to select tags that may reduce the amount of time and/or the number of inputs provided by a reviewer for each review. By increasing the accuracy of selection of tags, the number of reviewer inputs may be reduced and the review information obtained from a user about an object may be increased.

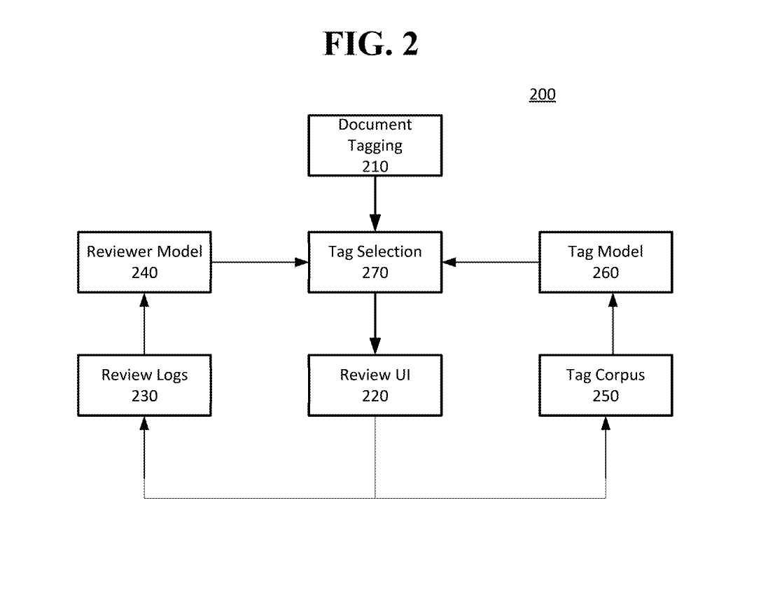

FIG. 2 shows hierarchical diagram of a structured review system 200 according to an embodiment of the disclosed subject matter. The structured review system 200 may include object tagging module 210, review user interface (UI) 220, the reviewer log module 230, reviewer model 240, the tag corpus module 250, tag module 260, and/or the tag selection module 27, as discussed in detail below.

Object tagging module 210 of the structured review system 200 may annotate each object with a collection of machine-readable tags. The tags may include topic tags, quality tags, price tags, and definable tags. For example, a social transit application to be reviewed can be tagged with “Topic: Transit”, “Topic: Subway”, or the like. Quality tags may describe the quality of the objects. For example, when the object to be reviewed is an application, the quality tags may be “Quality: Accurate”, “Quality: Unreliable”, or the like. In another example, where the object to be reviewed is a restaurant, the quality tags may include “Quality: High-End”, “Quality: Fast Food”, “Quality: Fancy”, “Quality: Casual”, or the like. Price tags may describe the price of the object with respect to value. For example, the price tags may include “Price: Expensive”, “Price: Moderate”, “Price: Cheap,” “Price: $20-$50,” “Price: $50-100,” or the like. In some embodiments, types of tags may be defined depending on the characteristics of the objects. Such tags may be referred to as definable tags.

The review user interface (UI) 220 of the structured review system 200 provides a user interface for a reviewer. Given the object (e.g., an app, a movie, a book, a hotel, a restaurant, a product, or the like) and the reviewer, the Tag Selection module 270 (as described in detail below) selects a set of tags from an object tag collection and present the tags within the UI for the reviewer. The UI may be displayed for example, on display 22 of device 20 shown in FIG. 4 and described below. The reviewer may be asked to remove the tags that are not related to the object, and may be asked to save and/or submits the rest of the tags (e.g., the tags that are not selected for removal) to the system. Although the UI can have different appearances, an example UI 300 is displayed in FIG. 3.

UI 300 shown in FIG. 3 includes a topic tag 310, a performance tag 320 (which is an example of a definable tag as discussed above), a quality tag 330, and a price tag 340 for an object that is an application (i.e., an app). Tags 310, 320, 330, and/or 340 may be removable by a reviewer by the respective selection of the removal buttons 315, 325, 335, and/or 345. When the reviewer has determined which tags to be removed, if any, the reviewer may select the submit button 350 of the UI 300 so as to save and/or submit the remaining tags (i.e., the tags that have not been removed). Although UI 300 shows four tags that include topic, quality, price, and performance, the UI 300 may include any suitable number and/or type of tags.

As shown in FIG. 2, the structured review system 200 may include review log module 230, which may log all of user review behavior (e.g., the reviewer behavior activity within the UI 300 or the like). For example, the reviewer log module 230 may monitor the date and time of the review activity, the tags selected and presented to the reviewer, the tags removed by the reviewer, the tags submitted by the reviewer, the time spent by the reviewer, or the like.

The reviewer model 240 of the structured review system 200 may predict the probability that the reviewer keeps a tag, given the reviewer's behavior history and object attributes. That is, the reviewer model 240 may predict the probability (P) of keeping a tag, given the reviewer, the object (“doc”), and the tag, as represented by P (keep|reviewer, doc, tag).

The reviewer model 240 may be built and/or developed in a plurality of ways. The following example provides a machine-learning based solution to build the reviewer module 240. Each triple (reviewer, doc, tag) can be represented by a feature vector. For example, the reviewer can have features like demographics, language, interests, or the like. The object (“doc”) can have features like the topic, number of likes, number of dislikes, quality, or the like.

The reviewer model 240 may process the review logs (e.g., the review logs of the review log module 230). Each previous user review may be treated by the reviewer module 240 as a machine learning training sample. If the reviewer elects to keep the tag presented to him/her (e.g., by the UI 300 shown in FIG. 3), the training sample may be labeled as positive, otherwise the training sample may be labeled as negative.

The reviewer model 240 may train a classification model from the training samples. Machine learning models that can be used as a classification model include a SVM (Support Vector Machine) model, logistic regression, or the like.

The tag corpus module 250 of the structured review system 200 shown in FIG. 2 may store tag-related information. For example, the tag corpus module 250 may store, for each object, a set of tags submitted (e.g., by selecting the submit button 350 of the UI 300 shown in FIG. 3) by one or more reviewers. The tag corpus module 250 may store each tag that is associated with a stats s(tag) that includes the number of times the tag is presented to the reviewers, the number of times the tag is removed by the reviewers, the number of times the tag is kept by the reviewers, and the like. For each reviewer, the set of objects reviewed by the reviewer may be stored, as well as the tags associated with each object that were submitted by the reviewer.

The tag model 260 of the structured review system 200 shown in FIG. 2 may model, for example, the probability that an object has a tag and/or entropy, which is a measure of the amount of information contained in a review about an object. The probability (P) that the object has a tag, i.e., P (tag doc, s(tag)) can be approximated by:

$$P ( tag \vert doc , s ( tag ) ) = \frac{number of times kept by the reviewers}{number of times presented by the reviewers}$$

That is, the above probability considers the number of times that a tag presented (e.g., in a user interface 300) to a reviewer is retained (e.g., tags that are not removed by a reviewer), and the number of times a tag is presented to a reviewer. It can indicate the relative popularity or unpopularity of a tag among reviewers. This information may be stored in the database, and may be associated with a particular reviewer and/or a particular object.

The probability that the object does not have a tag can be determined by:

P(̅t̅a̅g̅|doc, s(tag))=1−P(tag|doc, s(tag))

The entropy (E) of each tag in a object (i.e., “doc”) may be computed from the above probabilities by the following equation:

$$E ( tag \vert doc , s ( tag ) ) = - {\sum }_{t ∈ \{ tag , \overline{tag} \}} p ( t \vert doc , s ( tag ) ) ln ( P ( t \vert doc , s ( tag ) )$$

In the equation above, t may be an individual tag that is part of the set of tags T.

The more confidence that the tag is associated with the object, the smaller the entropy. The information gained from the tags can be measured by:

H(doc)=−Σ_{tag}E(tag|doc, s(tag))

The tag selection module 270 of the structured review system 200 shown in FIG. 2 may, given a particular object and a reviewer, select a set of tags from the object tag collection and may present the selected set of tags to the reviewer. The selected tags may minimize the number of discrete reviewer inputs (or overall input) for each review, and maximize the information gained from the review. It may be assumed that the reviewer needs fewer inputs if more tags are selected that the reviewer would likely keep (e.g., tags that have a higher probability that the reviewer would keep). This can be approximated by selecting tags that have high keep probability P (keep|reviewer, doc, tag), as detailed above in connection with reviewer module 240. The following equation may be used to approximate the number of reviewer inputs:

K(T)=|T|−Σ_{tεT}P (keep|reviewer, doc, t)

In the equation above, T may be set of tags selected and presented to the reviewer, and K is the approximate number of reviewer inputs (e.g., with K(T) being the approximate number of reviewer inputs for the set of tags selected and presented to the user). It may be assumed that more information can be gained if the reviewer can submit tags that fewer previous reviewers have evaluated. For example, if most of previous reviewers have submitted the tag “Topic: Social Network” for a social networking application, then the information gain can be very small if this tag is presented again to a present reviewer. The information gain can be approximated by information change ΔH(doc, T) after the tags are kept or removed by the reviewer:

ΔH(doc, T)=H(doc, T)−H(doc)

where H(doc, T) and H(doc) are the information after and before the reviewer submits the tags, respectively.

In the systems and methods disclosed herein, there can be different ways to select tags. In some embodiments, the systems and methods may find the set of tags T that maximize:

$${max}_{T} - K ( T ) + αΔ H ( doc , T )$$

In the above equation, α may be a predefined parameter that controls an importance of K or ΔH, where ΔH is the information change (e.g., the amount of information to be gained from the reviewer input regarding an object). The objective for each individual tag t may be computed by the following:

K(t)=1−P(keep|reviewer, doc, t)

ΔH(doc, t)=E(t|doc, s(t))−E(t|doc, s′(t))

F(t)=−K(t)+αΔH(doc, t)))

In the above equations, s(t) and s′(t) are review stats before and after a current reviewer adds tag t to the object, and F(t) relates to the number of user inputs and information gained.

The above objective function can then be factorized as

$${max}_{T} - K ( T ) + α Δ H ( doc , T ) = {max}_{T} {\sum }_{t ∈ T} F ( t )$$

That is, the optimal set of tags T is the tags that have largest F(t).

In situations in which implementations collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. Thus, the user may have control over how information is collected about the user and used by a system as disclosed herein.

Embodiments of the presently disclosed subject matter of structured review systems and methods may be implemented in and used with a variety of component and network architectures. FIG. 4 is an example of a computing device 20 suitable for implementing embodiments of the presently disclosed subject matter. For example, computing device 20 may display UI 300 shown in FIG. 3 and discussed above. The device 20 may be, for example, a desktop or laptop computer, or a mobile computing device such as a smart phone, smart watch, tablet, wearable computing device, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) that controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth(R), near-field, and the like. For example, the network interface 29 may allow the computer to communicate with other computers via one or more local, wide-area, or other communication networks, as described in further detail below.

Many other devices or components (not shown) may be connected in a similar manner (e.g., object scanners, digital cameras and so on). Conversely, all of the components shown in FIG. 4 need not be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 27, fixed storage 23, removable media 25, or on a remote storage location.

FIG. 5 shows an example network arrangement according to an embodiment of the disclosed subject matter. One or more devices 10, 11, such as local computers, smart phones, smart watches, wearable computing devices, tablet computing devices, and the like may connect to other devices via one or more networks 7. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platforms 17 or services provided by remote platforms 17 such as cloud computing arrangements and services. The remote platform 17 may include one or more servers 13 and/or databases 15.

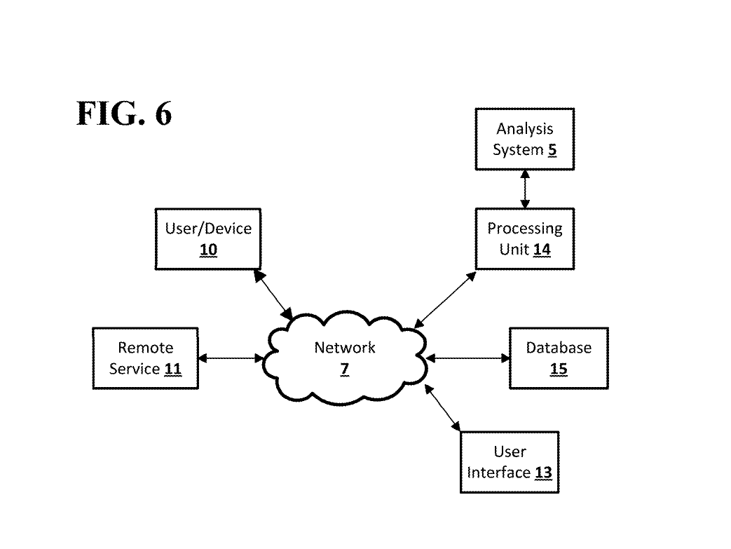

FIG. 6 shows an example arrangement according to an embodiment of the disclosed subject matter. One or more devices or systems 10, 11, such as remote services or service providers 11, user devices 10 such as local computers, smart phones, tablet computing devices, and the like, may connect to other devices via one or more networks 7. The network may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11.

The user interface 13, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
providing, with a computing device having an input device and a display device, a user interface to receive a review for an object from a reviewer;
selecting a set of tags from an object tag collection stored in a database communicatively coupled to the computing device according to the object and the reviewer;
displaying, by the display device of the computing device, the selected set of tags on a display;
receiving an input, by the input device, to remove one or more of the displayed tags; and
storing, by a storage device, the remaining tags of the set of tags that are submitted according to the received input for the object.

2. The method of claim 1, wherein the object is selected from the group consisting of: an application, a movie, a restaurant, a hotel, a tourist attraction, and a product.

3. The method of claim 1, wherein the set of tags are selected from the group consisting of:
topic tags, quality tags, price tags, and definable tags.

4. The method of claim 1, wherein the removed tags are not related to the object.

5. The method of claim 1, further comprising:
storing, by the database, a date and time of a review activity by the reviewer.

6. The method of claim 1, further comprising:
storing, by the database, the set of tags selected and displayed by the computing device for the reviewer.

7. The method of claim 1, further comprising:
storing, by the database, the one or more tags removed by the reviewer.

8. The method of claim 1, further comprising:
storing, by the database, time spent by the user for a review activity.

9. The method of claim 1, further comprising:
predicting, with the computing device, a probability that the reviewer submits a tag from the set of tags, according to a stored history of the reviewer and the object.

10. The method of claim 9, wherein the stored history of the reviewer includes at least one from the group consisting of: demographics, languages, and interests.

11. The method of claim 9, wherein the object has a feature from the group consisting of:
topic, number of likes, number of dislikes, and quality.

12. The method of claim 1, further comprising:
for each reviewer, storing, by the database, the set of objects reviewed and the tags associated with each object submitted according to the received user input from the reviewer.

13. The method of claim 1, wherein the selecting the set of tags from a object tag collection comprises:
selecting the set of tags so as to minimize the reviewer inputs for each review and maximize information obtained from the review.

14. A system comprising:
a computing device to provide a user interface to receive a review for an object from a reviewer;
a database communicatively coupled to the computing device to store an object tag collection;
a display device, coupled to the computing device, to display a set of tags selected by the computing device from the database;
an input device, coupled to the computing device, to receive an input to remove one or more of the displayed tags on the display device; and
a storage device, coupled to the computing device, to store the remaining tags of the set of tags that are submitted according to the received input for the object.

15. The system of claim 14, wherein the object is selected from the group consisting of: an application, a movie, a restaurant, a hotel, a tourist attraction, and a product.

16. The system of claim 14, wherein the set of tags are selected by the computing device from the group consisting of: topic tags, quality tags, price tags, and definable tags.

17. The system of claim 14, wherein the removed tags are not related to the object.

18. The system of claim 14, wherein the database stores a date and time of a review activity by the reviewer.

19. The system of claim 14, wherein the database stores the set of tags that are selected and displayed by the computing device for the reviewer.

20. The system of claim 14, wherein the database stores the one or more tags removed by the reviewer.

21. The system of claim 14, wherein the database stores time spent by the user for a review activity.

22. The system of claim 14, wherein the computing device predicts a probability that the reviewer submits a tag from the set of tags, according to a stored history of the reviewer and the object.

23. The system of claim 22, wherein the stored history of the reviewer includes at least one from the group consisting of: demographics, languages, and interests.

24. The system of claim 22, wherein the object has a feature from the group consisting of:
topic, number of likes, number of dislikes, and quality.

25. The system of claim 14, wherein the database stores, for each reviewer, the set of objects reviewed and the tags associated with each object submitted according to the received user input from the reviewer.

26. The system of claim 14, wherein the computing device selects the set of tags so as to minimize the reviewer inputs for each review and maximize information obtained from the review.

27. A non-transitory computer readable medium including instructions, that when executed by a computer, perform a method comprising:
selecting, with a server, a set of tags from an object tag collection stored in a database communicatively coupled to the server according to an object to be reviewed and a reviewer;
providing the selected set of tags from the server to a computing device of the reviewer;
receiving, with the server, input data from the computing device to remove one or more of the tags from the selected set of tags; and
storing, by a storage device, the remaining tags of the set of tags so as to be associated with the reviewer and the object.
